(19) United States
(12) Patent Application Publication
(10) Pub. No.: US 2005/0180838 A1
(43) Pub. Date: Aug. 18, 2005

(54) Self-piercing nut

(76) Inventor: Tadashi Shinjo, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/050,739

(22) Filed: Feb. 7, 2005

(30) Foreign Application Priority Data
Feb. 16, 2004 (JP) JP2004-037613

(51) Int. Cl. F16B 37/04

(52) U.S. Cl. 411/179

(57) ABSTRACT

A self-piercing nut has a main threaded cylinder (2) and a pilot (5) surrounding a threaded bore (3). The main cylinder has a lower end continuing to a flange (4), with the pilot (5) protruding from a central bottom of the flange so as to pierce a hole in a metal panel (11). A skirt (7) depends from the flange's periphery to serves as a seat (8) contacting the panel. An annular groove (9) is defined between the pilot (5) and skirt (7) such that the pilot is projected beyond the seat (8). The end face (6) of pilot has an outer diameter ‘B’ larger than that ‘A’ of the lower end of main cylinder (2). The outer periphery of pilot (5) is tapered to decrease its diameter inwards and to-wards the nut axis, and a corrugation (10) is formed in the outer periphery or in the inner periphery of skirt (7).

### FIELD OF THE INVENTION

The present invention relates to a self-piercing nut comprising a nut body for piercing a hole in a metal panel such that a generally circular edge of the hole is caulked to bite and fix the nut in position, even if the panel is a relatively soft aluminum plate or the like.

### BACKGROUND OF THE INVENTION

In these years, larger seat areas have been wanted from a viewpoint of mechanical strength for the seat portions of self-piercing nuts designed for attachment to the body panels of automobile cars. This requirement is important in a case wherein soft metal plates such as aluminum plates prone to undergo deformation are used to make the cars lighter in weight.

The Japanese Patent Laying-Open Gazette No. 2001-304226 shows an example of the self-piercing nut whose seat portion is of an increased area to meet the requirement mentioned above.

As shown in FIGS. 9 and 10, the prior art self-piercing nut 21 comprises a central threaded bore 23 penetrating a nut body. Such a female-threaded cylindrical body 22 has an expanded flange 24 that is formed integral with a lower end portion of this body 22. A pilot portion 25 protruding from a central region of the lower face of said flange 24 has an end face for punching a metal panel 35 to form a hole therein. A skirt 27 depends from the outer periphery of the flange 24 so as to serve as a seat portion 28 for contact with the panel 35. An annular groove 29 is thus defined between the pilot portion 25 and the skirt 27 in such a state that the pilot portion 25 has an end face 26 projected downwards a distance ahead the end face of seat portion 28.

In use, a region of metal panel 35 will be placed on a caulking die 32 so as to support the self-piercing nut 21, as seen in FIG. 9. A top face 22a of the female-threaded cylindrical body 22 will then be pressed downwards by a columnar striking punch 31. The pilot portion 25 of this nut 21 is thus forced to cooperate with the caulking die 32 to punch a hole through the region of metal panel 35. Consequently, a projected caulking rim 33 of the die 32 plastically deforms the circular edge 36 of this hole so that the nut is fixedly attached to the metal panel 35. In this case, the cylindrical body 22 of self-piercing nut will however be compressed in axial direction such that the pitch of screw threads of its threaded bore 23 does decrease, probably disabling a bolt to be screwed into this bore.

A cylindrical striking punch 34 for pressing the flange 24 as shown in FIG. 10 may substitute for the round punch discussed above. Such a punch 34 will prevent the problem of decreased thread pitch of threaded bore 23. In this case, the projected rim 33 of caulking die 32 takes a position inside the cylindrical punch. An annular pressing face of this punch 34 is however not in axial alignment with the caulking rim 33, thus bringing about another problem that the projected rim 33 fails to provide a strong and reliable caulking effect.

### SUMMARY OF THE INVENTION

An object of the present invention made in view of the drawbacks in the prior art is therefore to provide a novel self-piecing nut that has a seat portion of an increased contact area and is capable of being strongly attached to a metal panel by the caulking manner.

In order to achieve this object, a self-piercing nut proposed herein may comprise a nut body formed as a main threaded cylinder and a pilot portion that integrally protrudes from a central region of the nut body so as to surround an axial threaded bore thereof. The main threaded cylinder of this self-piercing nut continues to an expanded flange that is formed integral with a lower end portion of this cylinder. The pilot portion protruding from the central region of the lower face of said flange has an end face for punching a hole in a metal panel to which the nut is to be fixedly secured. A skirt depends from the outer periphery of the flange so as to serve as a seat portion for contact with the panel. An annular groove is thus defined between the pilot portion and the skirt in such a state that the pilot portion has an end face projected downwards a distance ahead the end face of seat portion. Characteristically, the end face of the pilot portion is of an outer diameter larger than that of the lower end portion of the main threaded cylinder, and an outer periphery of said pilot portion is tapered to decrease its diameter inwardly towards an axis of this nut. Also characteristically, the present nut may further comprise a plurality of protuberances and recesses (hereinafter referred to as corrugation) formed in either of facing peripheral walls around the pilot portion so as to extend along and in communication with the annular groove. The corrugation meant to include a series of indentations may consist of axial grooves formed in the outer periphery of pilot portion, or in the inner periphery of skirt.

Owing to the pilot portion end face whose outer diameter is larger than that of the lower end portion of the nut's main cylinder, the projected rim of a caulking die is capable of being aligned with the annular pressing face of a cylindrical striking punch. By virtue of this feature, the projected rim will ensure a strong and reliable caulking effect. As usual in operation of the conventional self-piercing nuts, the circular edge of a hole punched through a metal panel will forcibly be pressed and caulked into the annular groove. However, inherent in the present invention, the tapered outer periphery of pilot portion provided herein will effectively cooperate with the corrugation formed therein so as to strongly bite the caulked circular edge and firmly attach the nut to the metal panel.

Thus, the present self-piercing nut having a sufficient seat area will ensure a firm and sure caulking effect to be fixed on a metal panel, and will show a strong resistance to pulling-off and idle rotations. This nut is particularly adapted for attachment to aluminum plates or the like soft metal panels susceptive to deformation.

### BRIEF DESCRIPTION OF THE DRAWINGS

FIG. 1 is a front elevation of a self-piercing nut provided in an embodiment of the present invention and shown partly in vertical cross section;

FIG. 2 is a top plan view of the self-piercing nut of FIG. 1;

FIG. 3 is a bottom plan view of the self-piercing nut of FIG. 1;

FIG. 4 is a vertical cross section of the self-piercing nut being attached to a metal panel;

FIG. 5 is a front elevation of the self-piercing nut provided in another embodiment and shown partly in vertical cross section;

FIG. 6 is a bottom plan view of the self-piercing nut of FIG. 5;

FIG. 7 is a top plan view of the self-piercing nut provided in still another embodiment;

FIG. 8 is a front elevation of the self-piercing nut of FIG. 7 and shown partly in vertical cross section;

FIG. 9 is a vertical cross section of the prior art self-piercing nut being attached to a metal panel in one of the applicable manners; and

FIG. 10 also is a vertical cross section of the prior art self-piercing nut being attached to the metal panel in the other manner.

### THE PREFERRED EMBODIMENTS

Now some embodiments of the present invention will be described referring to the accompanying drawings.

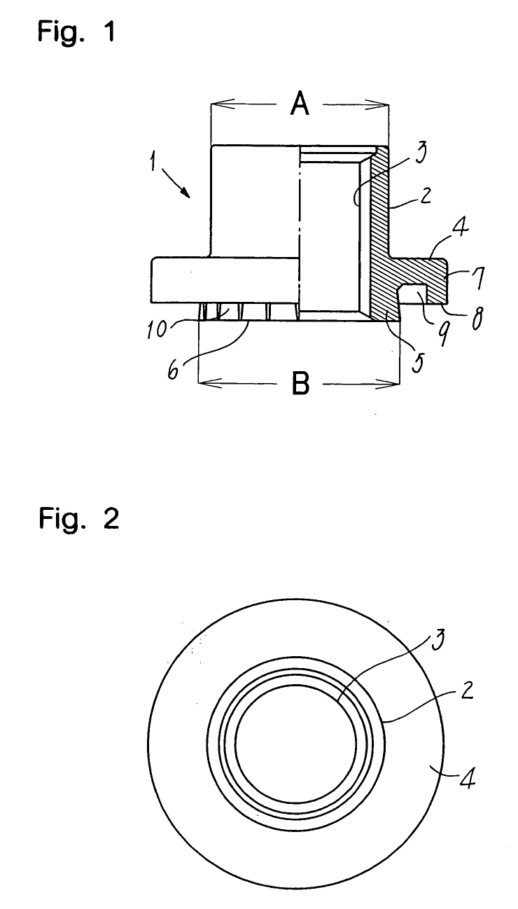

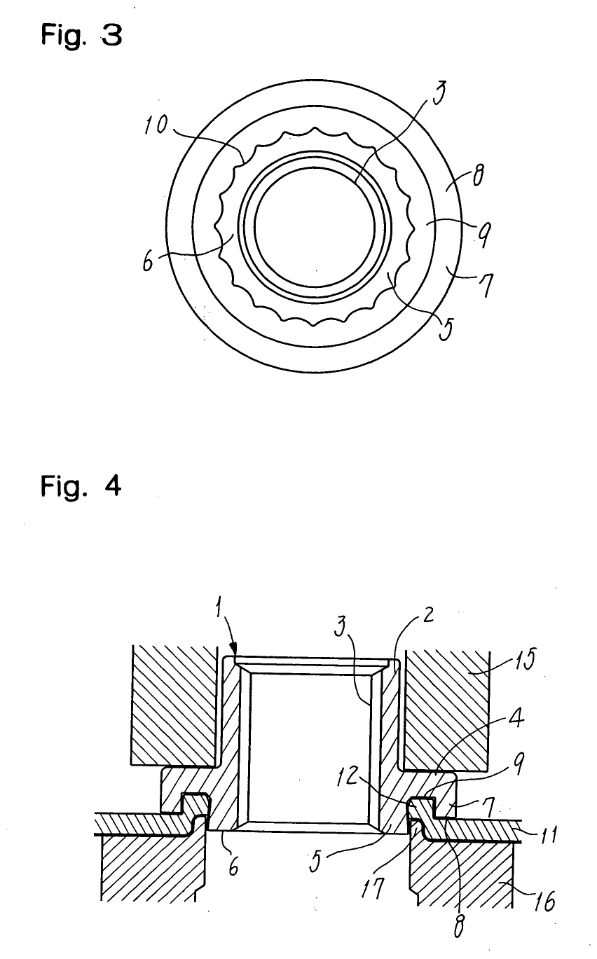

FIGS. 1 to 3 show a self-piercing nut 1 provided in an embodiment of the present invention. This nut 1 comprises a main threaded cylinder 2 having a threaded bore 3 and continuing to an expanded flange 4 that is formed integral with a lower end portion of this cylinder 2. A cylindrical pilot portion 5 integrally protrudes from a central region of the flange 4 so as to be coaxial with the main threaded cylinder 2 to surround the threaded bore. The pilot portion 5 has an end face for piercing a hole in a metal panel 11 (see FIG. 4). A skirt 7 formed as an outer peripheral and pendent wall of the flange does depend from the outer periphery of the flange 4. Thus, a seat portion is provided as a bottom face 8 of such a skirt 7, and an annular groove 9 is defined between the pilot portion 5 and the skirt. The pilot portion 5 has an end face 6 projected downwards a distance ahead the bottom face 8 of seat portion. The threaded bore 3 extends from the top of main threaded cylinder 2 to the bottom 6 of pilot portion 5. An outer periphery of the pilot portion is tapered to gradually decrease its diameter towards its upper end from its bottom 6. A corrugation 10 is formed in such a tapered outer periphery of the pilot portion. This corrugation 10 consists of a plurality of grooves extending generally in parallel with the nut axis and arranged at regular angular intervals around the nut axis. The end face 6 of the pilot portion 5 has an outer diameter ‘B’ larger than that ‘A’ of the lower end region of main threaded cylinder 2, wherein this end region is located adjacent to the flange 4. In use, the metal panel 11 will be set on caulking die 16 as shown in FIG. 4, and a striking cylindrical punch 15 kept in alignment with this die will subsequently press and urge downwards the flange 4. Thus, the pilot portion 5 cooperates with the caulking die 16, so that this die's projected rim 17 aligned with the pressing face of cylindrical punch 15 will pierce a hole in the panel 11. Simultaneously with such a piercing, a circular edge 12 of the hole will be forced into annular groove 9 in a caulking manner. As a result, the corrugation 10 formed in the inwardly tapered outer periphery of pilot portion 5 will bite the edge 12 to strongly attach this nut 1 to the panel 11. The large seat area 8 of flange 4 is thus firmly brought into and permanently held in a close contact with the metal panel 11. This effect is advantageous to improve the nut's resistance to pulling-off and idle rotations, even if the panel would be any soft aluminum plate susceptive to deformation.

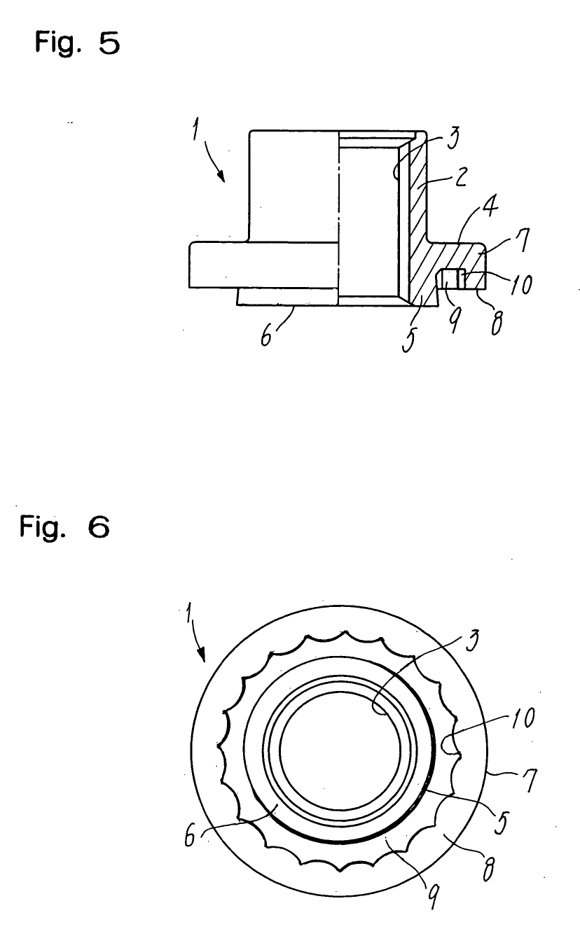

In the embodiment just described above, the corrugation 10 for preventing the self-piercing nut 1 from idle rotations relative to the metal panel 11 is formed in the outer periphery of pilot portion 5. However, such corrugation 10 may alternatively be formed in the inner periphery of skirt 7 as shown in FIGS. 5 and 6.

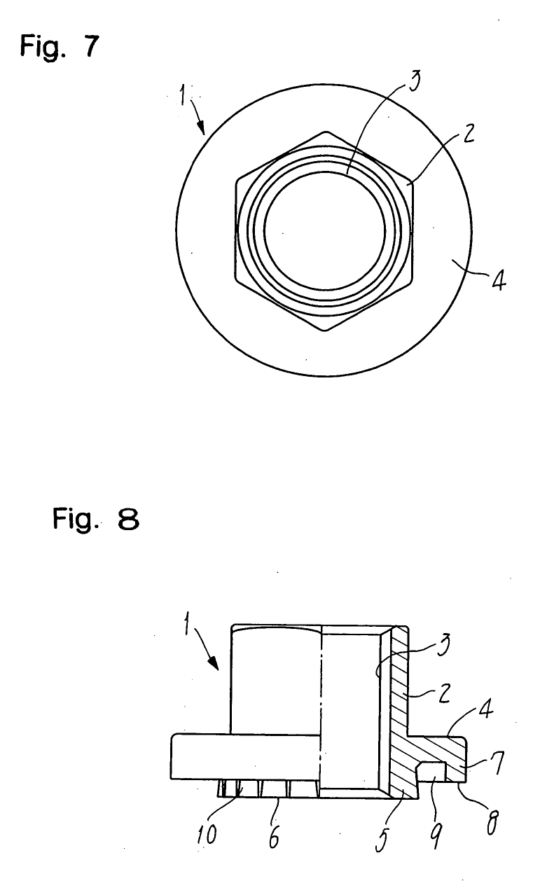

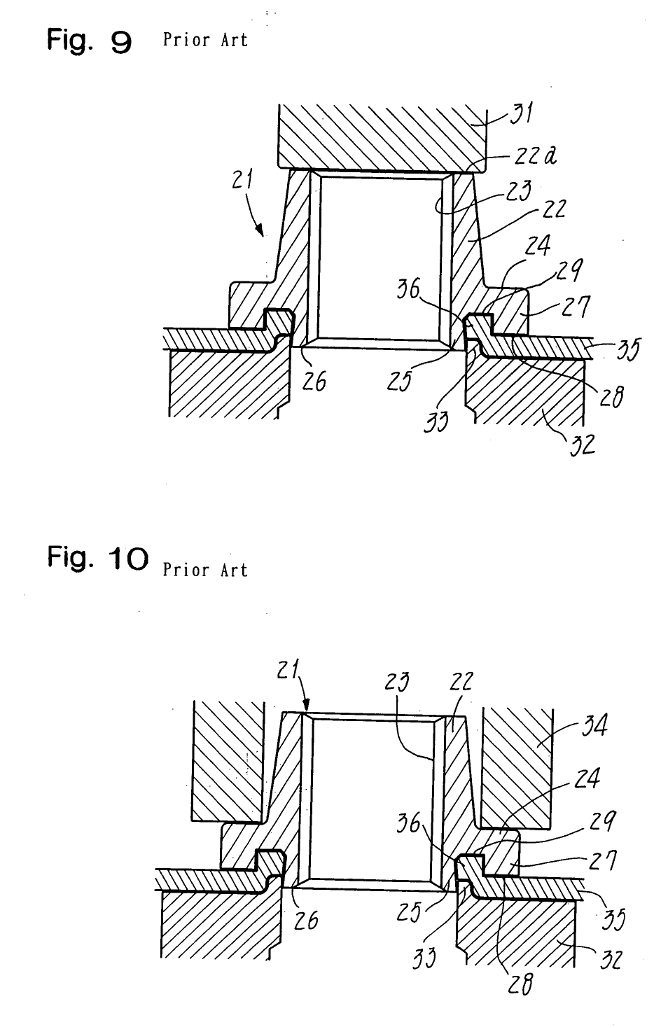

The main threaded cylinder 2 may not necessarily be round, but may alternatively be hexagon or any other polygonal shape in cross section as shown in FIGS. 7 and 8.

The present nut is not limited to use with any soft and readily deforming aluminum plate, but may be useful to afford a stronger caulking effect even for any other kinds of metal panels.

1. A self-piercing nut comprising: a nut body formed as a main threaded cylinder and a pilot portion that surrounds an axial threaded bore, the main threaded cylinder continuing to an expanded flange formed integral with a lower end portion of the cylinder, with the pilot portion protruding from a central region of a lower face of the flange and having an end face for piercing a hole in a metal panel to which the nut is to be fixedly secured, a skirt depending from an outer periphery of the flange so as to serve as a seat portion for contact with the panel, and an annular groove defined between the pilot portion and the skirt in such a state that the pilot portion has an end face projected downwards a distance ahead an end face of the seat portion,
wherein the end face of the pilot portion is of an outer diameter ‘B’ larger than an outer diameter ‘A’ of the lower end portion of the main threaded cylinder, an outer periphery of the pilot portion is tapered to decrease its diameter inwardly towards an axis of the nut, and a corrugation formed in either of facing peripheral walls around the pilot portion so as to extend along and in communication with the annular groove.

2. A self-piercing nut as defined in claim 1, wherein the peripheral wall in which the corrugation is formed as a plurality of axial grooves is the outer periphery of the pilot portion.

3. A self-piercing nut as defined in claim 1, wherein the peripheral wall in which the corrugation is formed as a plurality of axial grooves is an inner periphery of the skirt.
